(19) United States
(12) Patent Application Publication
(10) Pub. No.: US 2004/0053629 A1
(43) Pub. Date: Mar. 18, 2004

(54) Method and message server for conveying messages in a telecommunications network

(76) Inventors: Brian P. Rueger, Klotan (CH); Mark A. Woog, Winkel (CH)

Correspondence Address: Oliff & Berridge, Po Box 19928, Alexandria, VA, 22320, US

(21) Appl. No.: 10/250,425

(22) PCT Filed: Sep. 3, 2001
(86) PCT No.: PCT/CH01/00530

(30) Foreign Application Priority Data
Jan. 8, 2001 (WO) PCT/CH01/00012

(51) Int. Cl. H04Q 7/20

(52) U.S. Cl. 455/466

(57) ABSTRACT

The method, message server and the telecommunications network allow to convey messages, particularly short messages, originating in a mobile telecommunications network such as the GSM system and terminating at a recipient application or a related service in an IP-network not using the standards of said mobile telecommunications network. The inventive telecommunications network comprises a message server (WAMS) through which messages arriving at a first service centre (SC2) can be routed to a second service centre (SC1) which is connected to the recipient application or the related service. According to the inventive method a virtual mobile station number is established as the address for the recipient application, to which the entire community of short message mobile stations MS can originate messages as it would originate them towards a real mobile station MS.

The present invention relates to a method for conveying messages in a telecommunication network, to a message server and to a telecommunications network according to claim 1, claim 11 and claim 20.

More particularly the present invention relates to a method for conveying messages originating in a mobile telecommunications network for example as specified in the GSM (Global System for Mobile Communications) standards, the TDMA standards, the CDMA standards, the 3G standards (MMS) as well as in the Signalling System No. 7, IS-41 and IS-95 protocol standards and terminating in a network not using said standards but, for example, using the internetworking protocols TCP/IP instead. Networks using the internetworking protocols TCP/IP are the Internet, or corporate Intranets or Extranets. The term message used in this document particularly relates to short messages as defined in the above mentioned standards.

### BACKGROUND OF THE INVENTION

Modern mobile telecommunications networks such as the Pan-European Cellular System, known as the Global System for Mobile Communications GSM, allow the transfer of Short Messages between subscribers. An introduction to the GSM system can be found in [1], Lajos Hanzo, THE COMMUNICATIONS HANDBOOK, CRC PRESS, Boca Raton 1997, Chapter 87, pages 1226 ff. Below references are also given to [2], B. Walke, Mobilfunknetze und ihre Protokolle, Band 1, B. G. Teubner Verlag, Stuttgart 2000 and to [3], GSM Specification 03.40 concerning the technical realisation of the Short Message Service (SMS), the latter being herein incorporated by reference in its entirety. The transfer of Short Messages originating in a network working according to TCP/IP internetworking protocols (see [1], pages 702-704 or [7], Douglas E. Comer, INTERNETWORKING with TCP/IP, PRINCIPLES, PROTOCOLS, AND ARCHITECTURES, 4^{th} EDITION, Prentice Hall 2000, pages 183-195) and transferred and delivered through the ,GSM system to a subscribers mobile station according to [3], GSM Technical Specification 03.40, is described in [4], U.S. Pat. No. 5,768,509.

The GSM system uses the Signalling System Number 7 which has been enhanced by a Mobile Application Part (MAP) which is specified in [5] GSM Technical Specification 09.02 (Mobile Application Part (MAP) specification) as well as TDMA is enhanced with the IS-41 protocol. A description of Signalling System Number 7 and the IS-41 protocol is given in [1], chapter 35, pages 480 to 495 and [1], chapter 80.3, pages 1121-1123.

Transfer of short messages is preferably performed in the control channels SDCCH and SACCH ( [2], page 201 and 278-279). The protocol architecture of the Short Message System is shown in [3], chapter 9, page 30.

Transfer of short messages between terminals, mobile stations MS or fixed stations including data terminals, requires a service centre SC which is capable of

a) receiving a short message from a mobile station or over an interface from a data terminal within a TCP/IP network,

b) submitting a Short Message to a mobile station or over an interface from a data terminal within a TCP/IP network and

c) receiving and returning reports relating to sent or received short messages.

Fundamental procedures regarding the transfer of a short message from a service centre SC to a mobile station MS are shown in [3], pages 56 and 57; see also [3], Annex 2.

The short message is forwarded by the service centre SC to a gateway function GMSC which is a function of a mobile services switching centre MSC (in GPRS-Systems a message may transferred across a Serving GPRS Support Node SGSN, see [2], page 341 and page 389). The gateway GMSC is capable of interrogating a home location register HLR which contains routing information to the visited visitor location register VLR. The visitor location register VLR is the functional unit that attends to a mobile station MS operating outside the area of the home location register. A visiting mobile station MS is automatically registered at the nearest mobile services switching centre MSC and the visitor location register VLR is informed accordingly. Based on the retrieved routing information the gateway GMSC forwards the short message to the visited mobile services switching centre MSC. The visited mobile services switching centre MSC retrieves corresponding subscriber information from the visitor location register VLR based on which the short message is forwarded to the mobile station MS. Operations are terminated by returning a delivery report to the service centre SC of the network where the short message has been initiated.

Fundamental procedures regarding the transfer of a short message within a GSM system from a mobile station MS to a service centre SC are shown in [3], pages 64 and 65.

Before a short message is transferred the mobile services switching centre MSC retrieves information from the visitor location register VLR in order to verify that the requested service is available to the subscriber. Afterwards the short message is transferred via the mobile services switching centre MSC to an interworking function IWMSC belonging to a mobile services switching centre MSC. The interworking function IWMSC is capable of receiving a short message from within the public land mobile network PLMN and submitting it to a service centre SC which will forward the short message to the addressed subscriber as described above.

The mobile station MS will always address the required service centre SC by an E.164 address (see [3], page 24, paragraph 5.2.2). It is important to note that a subscriber with a mobile station MS will usually select the service centre SC of his network operator and not the service centre SC through which a message has been transferred to the subscriber if the message originates in another network. Additionally a subscriber may not be allowed to use a foreign service centre SC for submitting messages, as the concerned foreign network operator may enforce this by means of black or white listing.

Transfer of messages originating in an IP-network and being forwarded to a service centre SC will therefore be transferred from the service centre SC to the addressed mobile station MS as described above.

Transfer of messages originated by the mobile station MS to the user/application in the IP-network is only possible when the mobile station MS and the IP-network are connected to the same mobile network, provided the mobile station MS has rights to use the service centre SC in that network. However, this transfer is not possible when the mobile station MS is operating in another mobile network than the one to which the IP-network is connected to, since, as described above the transfer procedures comprise an access to the home location register HLR in order to retrieve the recipients data. Data of Internet-, Intranet- or Extranet users are however not registered in the home location register HLR resulting in a failure of the transaction.

The present invention is therefore based on the object of specifying a method, a message server and a telecommunications network for conveying messages, particularly short messages, originating in a mobile telecommunications network such as the GSM system and terminating in a network, such as an IP-network, which is not using the standards of said mobile telecommunications network.

It is another object of the invention to enable a subscriber to a mobile telecommunications network to send messages to a terminal or an application connected to a network using the internetworking protocols TCP/IP or to another connectionless packet switching network.

It is a further object of the invention to provide a message server for handling said messages which can easily be operated and integrated into said telecommunications network.

### SUMMARY OF THE INVENTION

The above and other objects of the present invention are achieved by a method, a message server and a telecommunications network according to claim 1, claim 11 and claim 20.

The inventive method allows to convey messages, particularly short messages, originating in a mobile telecommunications network such as the GSM system and terminating at a recipient application or a related service in an network not using the standards of said mobile telecommunications network.

Messages sent within a mobile telecommunications network to a service centre SC which is not linked to the recipient application or a related service are forwarded over a direct path to the inventive message server WAMS (Wireless Application Message Server) which delivers the messages to the recipient application or a related service in a network, such as an IP-network, not using the standards of said mobile telecommunications network.

Messages received by the message server are forwarded directly or indirectly to the application in the network, which is not using the standards of said mobile telecommunications network.

The received messages may be forwarded to a service centre SC which over a gateway function forwards the message to the hosted application. The message server may however itself incorporate a gateway function providing access to the network, e.g. an IP-network, through which the application can be reached. Furthermore messages may be stored in the message server WAMS and then retrieved by the addressed applications. In addition the message server may act as a host for the addressed applications.

The messaging services of the mobile telecommunications network are therefore extended to providing messaging channels to users of applications or a related service operating in a network specified for example according to the internetworking protocols TCP/IP or other connectionless packet switching networks, across several wireless networks.

The expanded messaging services can be made available to individual subscribers or commercial providers which can open an account at the operators of the message servers WAMS or the service centres SC. Individual subscribers will preferably use the services of commercial providers which take care of negotiations with the network operators.

The message server WAMS uses signalling functions, such as the functions of the Signalling System Number 7, according to the standards of said mobile telecommunications network and can therefore easily be incorporated into the mobile telecommunications network. No proprietary transactions are used at the interface level between the inventive message server WAMS and the mobile telecommunications network, so as to use the full potential of the capabilities of the mobile telecommunications network and to minimise cost of the realisation and integration of the inventive solution. This in parallel results also in small cost for operation and maintenance.

The message server preferably handles the recipient applications or the related services as virtual mobile stations thus facilitating signalling operations.

In a further preferred embodiment of the message server comprises the functionalities of a short message service center and is therefore capable of also forwarding messages received from any internal short message entities such as mobile stations or external short message entities such as applications operating in an IP-network to mobile stations connected to the mobile telecommunications network.

The inventive telecommunications network realised with the integration of the inventive message server within one mobile telecommunications network may incorporate several public land mobile networks PLMN connected to connection oriented or connectionless packet switching or circuit switched networks.

### BRIEF DESCRIPTION OF THE DRAWINGS

Some of the objects and advantages of the present invention have been stated, others will appear when the following description is considered together with the accompanying drawings, in which:

FIG. 1 shows a known telecommunications network designed to convey messages originating in the Internet or an Intranet and terminating in mobile stations of a first or a second public land mobile network PLMN,

FIG. 2 shows the inventive telecommunications network capable of conveying messages originating in mobile stations of a first or a second public land mobile network PLMN and terminating in the Internet or an Intranet,

FIG. 3 shows the protocol layers of the signalling system No. 7 used in a GSM system for a home location register HLR and for a mobile switching services centre MSC,

FIG. 4 shows the transactions performed for transferring a message from a first service centre SC over the inventive message server to a second service centre SC,

FIG. 5 shows transactions performed in the inventive message server after the receipt of a message which over different pathways may reach the addressed application,

FIG. 6 shows the transfer of received messages from the message server to a storage unit from where they can be retrieved by corresponding applications,

FIG. 7 shows the transfer of received messages from the message server to a storage unit from where they can be retrieved by corresponding applications via a proxy server,

FIG. 8 shows the direct transfer of received messages from the message server to corresponding applications,

FIG. 9 shows the transfer of a message from a mobile station to an application hosted in the message server which in response returns a message to the mobile station via service center SC2,

FIG. 10 an inventive message server comprising a gateway function,

FIG. 11 the inventive message server acting as service center while forwarding a message to a mobile station and

FIG. 12 the inventive message server acting as service center while receiving a message from a mobile station.

### DETAILED DESCRIPTION OF THE PREFERRED EMBODIMENTS

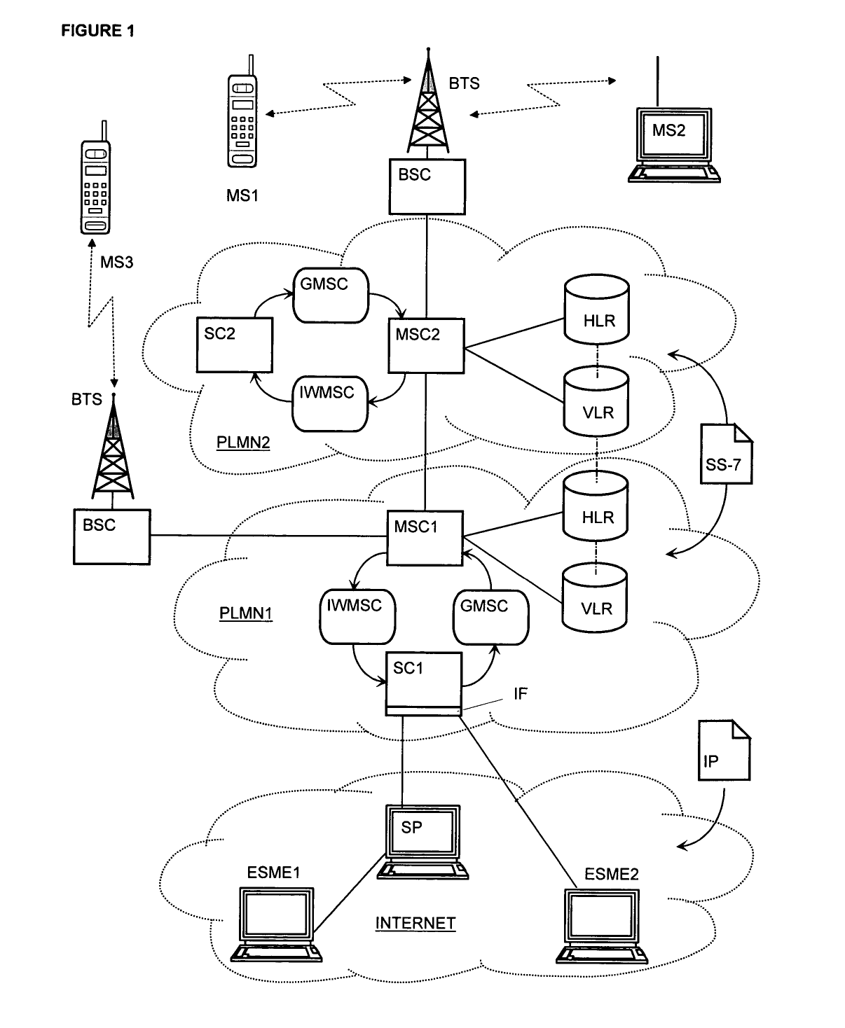

FIG. 1 shows a known telecommunications network designed to convey messages originating in the Internet or an Intranet and terminating in mobile stations of a first or a second public land mobile network PLMN1; PLMN2. The structure of a GSM public land mobile network PLMN is shown and described in [1], pages 1226 to 1228. For TDMA systems using the IS-41 protocol and CDMA systems using the IS-95 protocol see [1], chapter 80.3, pages 1121-1123 or [1], chapter 89, pages 1257-1263.

A GSM public land mobile network can be viewed as a configuration comprising

a) a user level with voice and data terminals MS1, MS2, MS3, PC1, PC2 and SP;

b) a network level with mobile services switching centres MSC1, MSC2; short message service centres SC1, SC2; gateway functions GMSC and interworking functions IWMSC belonging to a mobile services switching centre MSC and base station tranceivers BTS and thereto related base station controllers BSC;

c) a database level with home location registers HLR, visitor location registers VLR and Equipment Identity registers (not shown as this optional network entity is not relevant for the scope of this document) and

d) a signalling level working according to the Signalling System No. 7 with signalling points connected to the elements of the database level and with signalling points connected to the switching elements of the network layer.

In a different view the mobile stations MS, the base station tranceivers BTS and thereto related base station controllers BSC are contained in a Radio Subsystem, the mobile services switching centres MSC1, MSC2; short message service centres SC1, SC2; gateway functions GMSC and interworking functions IWMSC as well as the home location and visitor location registers HLR, VLR are contained in a Network and Switching Subsystem NSS and a Operation and Maintenance Centre (not shown), an Authentication Centre (not shown) and an Equipment Identity Register (not shown) are contained in an Operation Subsystem.

Fundamental procedures regarding the transfer of a short message from a mobile station MS to a service centre SC and from the service centre SC to a mobile station MS were described above.

The service centre SC1 shown in FIG. 1 may, as described in [4], be a work station comprising a memory to store short messages and subscriber data. The service centre SC1 is over a gateway and an interworking function on one side connected to the mobile switching services centre MSC1. On the other side, over a TCP/IP interface IF, the service centre SC1 is connected to Internet or Intranet network entities SP and PC2 which comprise services and applications capable of sending messages to the service centre SC1 where the addresses of said services and application are stored in a database. Preferably individual subscribers PC1 access the service centre SC1 over a service provider SP.

As mentioned above messages can be sent in the telecommunication network shown in FIG. 1 from the Internet network entities SP, PC1 and PC2 over the public land mobile network PLMN1 and PLMN2 to the mobile stations MS1, MS2 and MS3. On the reply path, described in [3], Annex 4, the service centre SC1 will also receive a delivery report. Mobile stations MS1, MS2 and MS3 which are not registered at the service centre SC1 will however not be able to initiate or return in reply a message to the Internet or Intranet network entities SP, PC1 and PC2 since the service centre SC2 in the public land mobile network PLMN2 in which the mobile stations MS1, MS2 and MS3 are registered for example, does not have access to address or routing information for the Internet network entities SP, PC1 and PC2.

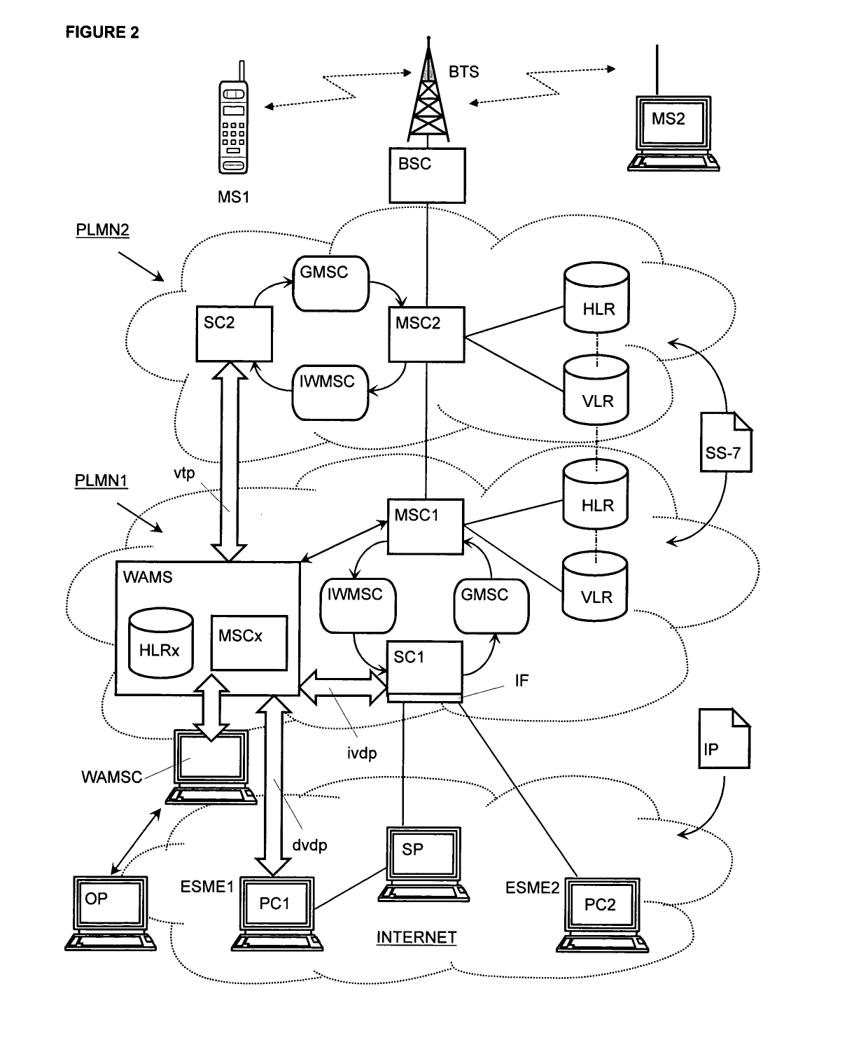

FIG. 2 shows the inventive telecommunications network capable of conveying messages originating in mobile stations MS1 and MS2 of a first or a second public land mobile network PLMN1, PLMN2 and terminating in the Internet or in an Intranet.

As drawn in FIG. 2 the inventive solution is based on the idea of forwarding the messages from the first service centre SC2 accessed by the mobile stations MS1 and MS2 over a message server WAMS to the second service centre SC1 on a path shown with virtual connections vc1 and vc2.

The inventive solution is further based on the idea of representing applications to which messages are sent, afterwards called recipient applications, as virtual mobile stations equipment with virtual mobile address information such as a virtual mobile station number i.e. a Mobile Station International ISDN Number (MSISDN) and a corresponding International Mobile Station Identity (IMSI).

Hence any mobile station MS in a first or second public land mobile network PLMN1, PLMN2 is able to directly exchange messages with recipient applications located within a TCP/IP network connected to one of the public land mobile networks PLMN1, PLMN2 as if said mobile stations MS were exchanging messages with any other mobile stations MS of said networks PLMN1, PLMN2.

Messages sent by the mobile stations MS1 and MS2 to said virtual mobile stations are forwarded to the message server WAMS where corresponding address information of the recipient application and the service centre SC1 connected thereto is retrieved. Said address information preferably comprises the E.164 address of the service centre SC1 and the address and preferably address type of the recipient application or a related service.

Based on the retrieved information the message is forwarded from the message server WAMS to the service centre SC1.

In order to store the above mentioned address information the message server WAMS comprises a database HLRx and switching function MSCx which towards the mobile telecommunications network act as a standard home location register HLR or as standard mobile services switching centre MSC and which are therefore accessible by means of the signalling system (Signalling System No. 7) from all other entities of the interconnected mobile telecommunications network which act as signalling points.

The above described address information (virtual subscriber number, IMSI, E.164 address of the service centre SC1 and the application or service number) required for the transfer of messages are updated in the database HLRx by means of a control unit WAMSC such as a workstation. Maintenance of the data in the database HLRx may also be performed by means of a workstation OP of an Operator. In a preferred embodiment the data in the database HLRx may be maintained by the service provider SP.

In order to send a message to an Internet network entity SP, PC1 and PC2 the user of a mobile station MS1, MS2 needs to know only the virtual mobile station number of the recipient application.

The procedures for the transfer of a message from a mobile station MS to a service centre SC which are also used by the inventive solution have been described above. The inventive solution, which takes care that the message arriving at a service centre SC2 selected by the corresponding subscriber as the default service centre will be forwarded to the service centre SC1 linked to the recipient address, will be described for a mobile telecommunications network using the Signalling System No. 7 in detail below.

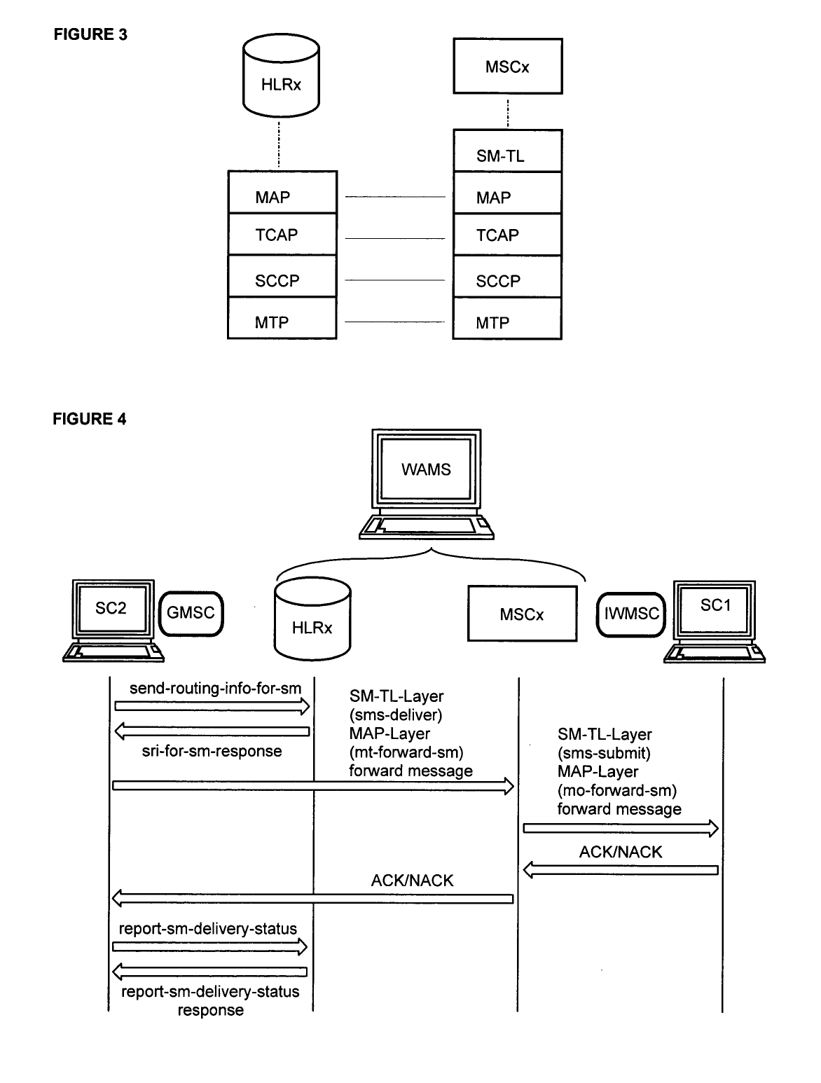

FIG. 3 shows the protocol layers of the Signalling System No. 7 used in a GSM system for home location registers HLR and for mobile switching services centres MSC. Signalling System No. 7 is an out-of-band signalling concept which was designed to control telephone switching equipment within the Integrated Services Digital Network (ISDN). Signalling The protocol architecture of Signalling System No. 7 comprises

a) a Message Transfer Part MTP consisting from bottom to top of

a1) Signalling Data Link Functions (MTP Level 1) corresponding to Layer 1 of the OSI Model,

a2) Signalling Link Functions (MTP Level 2) corresponding to Layer 2 of the OSI Model and

a3) Signalling Network Functions (MTP Level 3) corresponding to a first part of Layer 3 of the OSI Model;

b) a Signalling Connection Control Part (SCCP) enhancing the functions of MTP Level 3 in order to provide the functional equivalent of OSI's network layer 3 and

c) application protocols (corresponding to Layer 7 applications of the OSI Model) such as the Transaction Capabilities Application Part (TCAP) which provides services for User Parts such as the Mobile Application Part (MAP) which was created for the GSM system.

The procedures specified in the protocols of the above mentioned layers (MTP, SCCP, TCAP and MAP) are sufficient to enable communication with a home location register HLR as well as the database HLRx of the message server WAMS (the database HLRx, which has been extended for the purposes described herein, supports external queries typical for a standard home location register HLR).

In order to enable subscribers of the GSM system to exchange short messages the protocols of the Short Message Transfer Layer SM-TL have been created. The services provided by the Short Message Transfer Layer SM-TL enable the application layer above to transfer short messages to its peer entities. The Short Message Transfer Layer SM-TL comprises Protocol Data Units PDU:

SMS-DELIVER conveying a short message from the service centre SC to the mobile station MS,

SMS-SUBMIT conveying a short message from the mobile station MS to the service centre SC,

SMS-COMMAND conveying a command from the mobile station MS to the service centre SC

and SMS-DELIVER-REPORT, SMS-SUBMIT-REPORT, SMS-STATUS-REPORT.

FIG. 4 shows the transactions performed for transferring a message from a first service centre SC2 over the inventive message server WAMS to a second service centre SC1. Assuming that service centre SC2 has received a message according to the procedures described above it either forwards the message directly to an addressed mobile station MS or, in case that the message should reach a recipient application, the message is forwarded based on a contained virtual mobile station number (MSISDN) as destination address to the message server WAMS. Based on the information in the database HLRx of the message server WAMS address data corresponding to the virtual mobile station number is retrieved and used for the forwarding of the message as a new destination address. The message is therefore forwarded to the service centre SC1 whose address has been retrieved from the database HLRx with the destination address of the recipient application or a related service.

With the MAP-layer commands SEND-ROUTING-INFO-FOR-SM and SEND ROUTING-INFO-FOR-SM RESPONSE the service centre SC2 or a related gateway function GMSC retrieves routing information from the database HLRx based on which the message is delivered to the switching functions MSCx by means of an SMS-DELIVER protocol data unit.

The switching function MSCx of the message server is addressable like a standard mobile services switching centre MSC. Whenever the service centre SC2 needs to deliver a message it will first query the database HLRx with the virtual mobile station number i.e. the Mobile Station International ISDN Number (MSISDN) in order to obtain the International Mobile Station Identity (IMSI) and the address of the mobile services switching centre i.e. the switching function MSCx which is serving the addressed object (a recipient application instead of an actual mobile station MS). Subsequently the message is delivered with said SMS-DELIVER protocol data unit comprising as RP-DESTINATION-ADDRESS the International Mobile Station Identity (IMSI).

The switching function MSCx will translate the International Mobile Station Identity (IMSI) to the address of the recipient application on the hosting service centre SC1 to which the message is forwarded by means of an SMS-SUBMIT protocol data unit. The SM-TL-layer SMS-DELIVER event is therefore changed into an SM-TL-layer SMS-SUBMIT event as otherwise the addressed service centre SC would reject the message. Based on the address of the recipient application the message can be terminated in a way as it would be done on the reply path (see [3], Annex 4).

Based on the inventive idea of using virtual mobile station numbers it would be possible to use different routing procedures in the message server WAMS. However the described mode of the invention avoids proprietary functions which would be time consuming to implement.

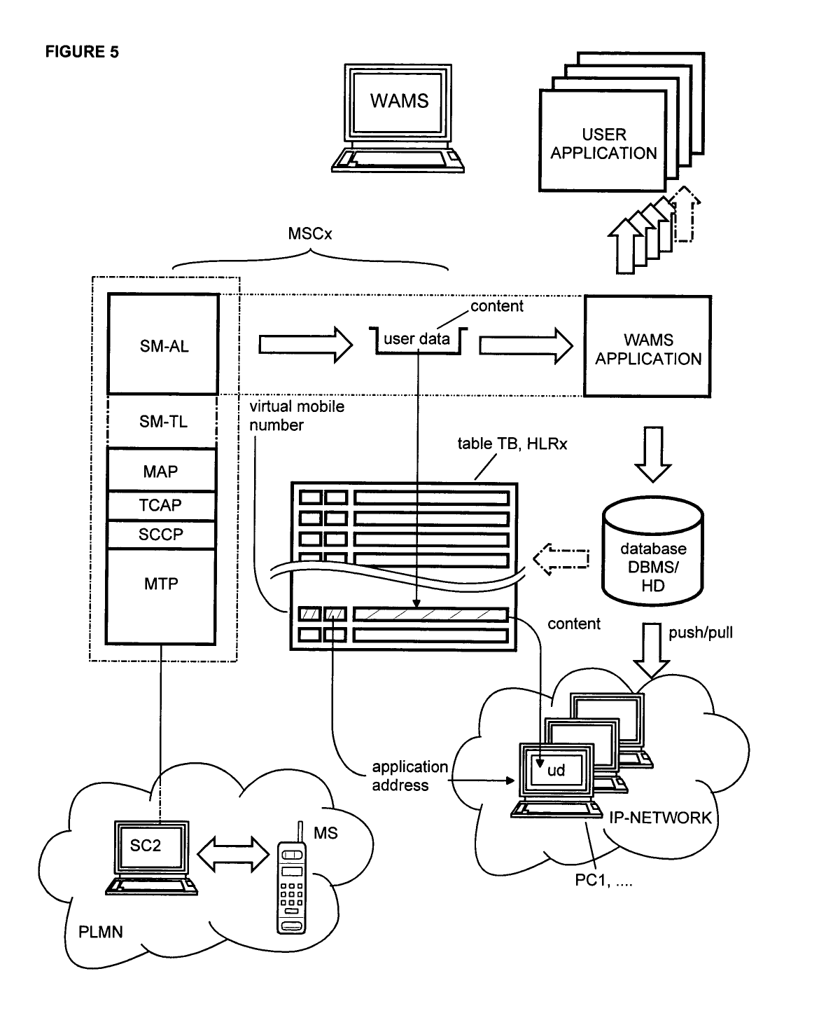

FIG. 5 shows an inventive message server WAMS using different routing procedures for conveying messages, particularly short messages, originating in a mobile telecommunications network such as the GSM system and terminating at a recipient application or a related service in a network such as an IP-network which is not using the standards of said mobile telecommunications network.

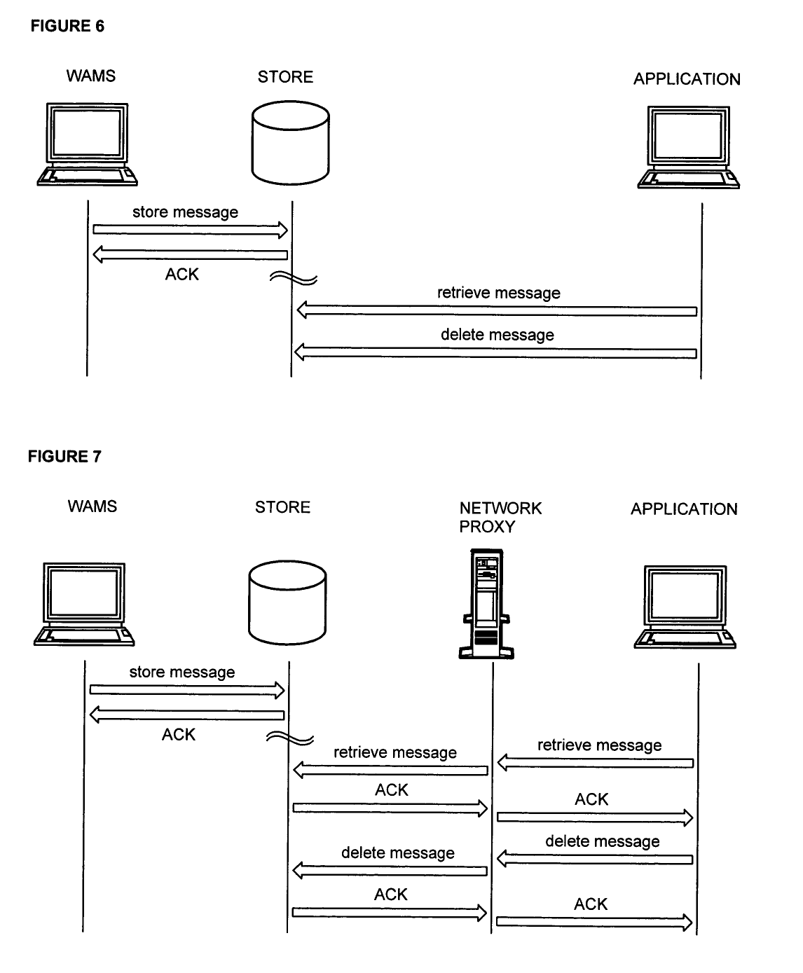

The message server WAMS forwards a received message or its content to a storage unit such as a hard disk HD or a database management system DBMS (see FIG. 5) from where it can either be forwarded further to the recipient application or a related service or from where it can be retrieved directly (see FIG. 6 or via a Proxy Server by the application (see FIG. 7). Functionality of a Proxy Server is described in [7], chapter 28.14, pages 535-536.

A database DBMS stores a set of data in most of the times proprietary format on a storage device such as a hard disk HD. A database DBMS offers more functionality concerning management, retrieval and storage of data than a common storage device does.

A database, which may be a self-developed and proprietary software layer offering extended management, retrieval and storage capabilities compared to an ordinary storage device access, is normally accessed using TCP/IP by means of one of the following protocols:

ODBC,

JDBC,

OLE-DB,

Native Database Access.

Examples for databases are Oracle, Microsoft SQL Server, mySQL, PostgreSQL, etc. Another form of databases are directories like X.500 or LDAP (Lightweight Directories).

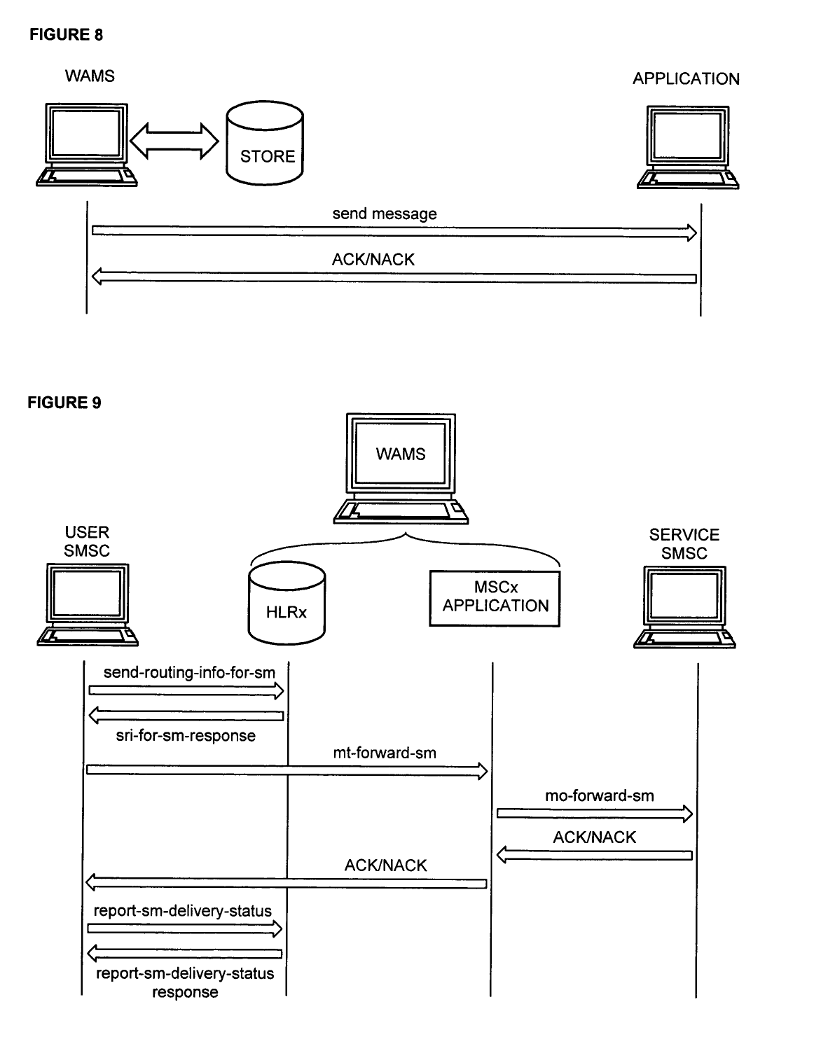

In a further embodiment of the invention the message server WAMS forwards a received message directly to the recipient application (see FIG. 8).

As shown in FIG. 5 messages received from the mobile telecommunications network PLMN are terminated while being transferred through the protocol stack of the Signalling System No. 7 including the mobile application part MAP and the protocol layers of short message user application as shown in [3], page 30. Regarding the architecture of the Signalling System No. 7 see [6], Wolf-Dieter Haaβ, Handbuch der Kommunikationsnetze, Springer Verlag, Berlin 1997 page 509, figures 8.4 and 8.5 as well as page 524, figure 8.15.

As discussed above and shown in FIG. 4 the message server WAMS receives a protocol data unit SMS-DELIVER, which according to [3], page 3.4, paragraph 9.2.2 serves for conveying a short message to a mobile station, i.e. in the message server WAMS to a virtual mobile station. The protocol data unit SMS-DELIVER comprises in the TP-UD section the user data (see [3], page 36) which according to the present invention will be routed to the recipient application.

In the routing procedure selected in the embodiment shown in FIG. 4, the user data extracted from the protocol data unit SMS-DELIVER is transferred and inserted in the TP-UD section of a protocol data unit SMS-SUBMIT which is forwarded to service center SC1 and further to the recipient application.

In the embodiment of the message server WAMS shown in FIG. 5 the user data or the content of the short message is extracted by an application in the short message application layer SM-AL, e.g. the shown WAMS application, and forwarded directly to user applications hosted in the message server WAMS itself or operating in a further network such as an IP-network, or stored in a local storage unit such as a hard disk or in a database application from where it can be forwarded to or retrieved by the recipient applications operating for example in an IP-network.

As shown in FIG. 5, the user data could be entered in a table TB with numerous rows comprising a field indicating the virtual mobile number, a field with the address of the application in the IP-network and a field for entering the user data.

The short message is therefore transferred from the service center SC2 to which the originating mobile station MS is attached (see FIG. 5) via the message server WAMS to the recipient application without requiring a further service center.

In case that the message server WAMS forwards messages directly (not via a further service center SC1) to the recipient application, a database HLRx and a switching function MSCx will still be required in order to store routing information and to transfer or allocate an incoming message, addressed with a virtual mobile number, to a recipient application according to the routing data contained in database HLRx.

As shown in FIG. 5 table TB comprises a virtual mobile number and the corresponding address of the recipient in fields of a common database record which may further comprise a field for entering the content or user data to be transferred between the concerned short message entities MS, PC1, . . . . However, as described below, it is also possible to forward a message without intermediate storage of content in table TB.

The message server WAMS can forward messages to recipient applications as follows:

a) messages are forwarded by the message server WAMS via a service center SC to the recipient application (see FIG. 4);

b) messages are stored by the message server WAMS in a storage unit or facility, for example in table TB of FIG. 5 containing routing information, and then retrieved directly or via a proxy server by the recipient application (see FIGS. 6 and 7);

c) messages are stored by the message server WAMS in a storage unit or facility and then forwarded directly or via a proxy server to the recipient application (FIG. 8);

d) messages are pushed directly or via a proxy server to the recipient application (FIG. 8); or

e) messages are forwarded within the message server WAMS to a hosted application, which is operating as a module combined with modules of the message server WAMS (FIG. 9).

The storage unit or facility in the message server WAMS can be any means for saving or storing incoming messages such as a random access memory RAM, flat files on a hard-disk or in Storage Area Network (SAN), or a database managed by a high level application.

A recipient application accesses the information in either a direct access mode where it is using the standard interface offered by the storage facility or through an additional application which allows the application to access the messages over a network using IP.

In the embodiment of FIG. 6 the application accesses the storage facility, in order to retrieve the information, by using a standard interface offered by the storage facility or the corresponding operating system.

The retrieval of the information, i.e. the stored messages, can happen at any time as the messages are stored on the storage facility until they are retrieved and explicitly deleted by the application.

If the application has not the means or the rights to access the storage facility directly, an additional application may be provided offering an interfacing portal to access the messages using a network protocol such as TCP/IP or other. The communication with the storage facility is therefore provided by a third application.

In FIG. 7, a pull mechanism is shown meaning that the recipient application actively has to retrieve the messages (PULL) from the storage unit of the message server WAMS whereas the network proxy could also initiate a push of the message to the application whenever a new message is stored (PUSH).

In this case, the storage facility offers the “storing”-part of the “store-and-forward” service offered by this implementation in general. The network proxy or server on the other hand, takes the “forwarding” task, being a push- or pull-function. The protocol used between the network proxy and the application will preferably be IP-based although other protocols like DECnet or X.25 are applicable as well.

The network proxy could also be a mail server using for example the mail transfer protocol SMTP to send incoming messages in the form of e-mails to another mail server where the application can pick them up, or being directly accessed by the application.

Another embodiment of the invention is shown in FIG. 8, where the storage facility is omitted and the message server WAMS pushes incoming messages directly to the recipient application which then acknowledges receipt. A network protocol will be used which is most likely TCP/IP. The transport protocol can be HTTP using XML or any other proprietary protocol.

In a further embodiment of the invention, shown in FIG. 9, the message server WAMS and at least on recipient application are directly coupled or are running as one software entity. For example, the mobile services switching centre MSC and the application are merged into one module.

The (virtual) mobile terminated message MT-FORWARD-SM would therefore immediately reach the recipient application hosted in the message server WAMS, and could be replied by means of a (virtual) mobile originated message MO-FORWARD-SM which would be forwarded as any other message in a mobile telecommunications network via a service center (service SMSC) to the concerned mobile station.

In this case, the (virtual) mobile originated message MO-FORWARD-SM does not contain the original information but a response of the application hosted in the message server WAMS for example with a content request by the mobile user.

The communication between an application operating in a network such as an internet and the message server WAMS can be performed in the same manner an application would communicate with a service center SC.

As described in [4] , column 3, lines 55-67 a service centre SC preferably provides the capability of interfacing to external entities through an IP-TCP short message client interface. Other service centres SC may use instead of the internet protocol IP the X.25 PLP Packet Layer Protocol as described in [8], chapter 5.5.1, pages 350-358, and a corresponding transport protocol on top of X.25 PLP Packet Layer Protocol and underlying X.25 layers 1 and 2 as described in [8], chapter 6.3, pages 411-420.

Vendors have developed proprietary protocols in order to send and receive short messages transferred over a selected transport layer as described above.

Using the Short Message Peer to Peer Protocol Specification v3.4, issued 1999 by the SMPP Developers Forum, an external short message entity may initiate an application layer connection with a service centre SC over a TCP/IP or an X.25 network connection and may then send and receive short messages to and from the service centre SC respectively (see [9], SMPP Protocol Specification v3.4, chapter 1.1., page 8).

According to the described method external short message entities must therefore use a proprietary application according to the SMPP- or another proprietary protocol in order to exchange short messages with a service centre SC incorporating an interface working according to said proprietary protocol. (see for example [9], chapter 2.1, page 13, figure 2-1).

The commonly used proprietary service centre SC to short message entities SME interface specifications are listed in [10], ETSI technical report ETSI TR 123 039 V.3.2.0 (September 2000), on pages 5 and 6 as follows:

a) Short Message Peer to Peer (SMPP) Interface Specification (SMPP Forum)

b) Short Message Service Centre external machine interface (Computer Management Group)

c) SMSC to SME Interface Specification (Nokia Networks)

d) SMSC Open Interface Specification (SEMA Group)

e) SMSC Computer Access Service and Protocol Manual (Ericsson)

Applications operating in the Internet, below called clients, need therefore to implement and maintain at least one of said proprietary protocols in order to communicate with a service center or a the message server WAMS. Service centres SC are therefore unable to provide access to short message services to all Internet users. In case that a client accesses a different service centre SC a peer-to-peer condition may not be established due to the use of different protocols.

Short messages could however also be conveyed between the message server WAMS and applications or clients in an IP-network using a standardised communication protocol such as the Hypertext Transfer Protocol HTTP (see [7], chapter 28, pages 527-537) or a derivative thereof by

a) converting messages within the message server WAMS into messages based on the standardised communication protocol used by the recipient applications in the IP-network and forwarding the converted messages to the recipient applications and

b) receiving messages in the message server WAMS from applications in the IP-network based on a protocol used by said applications and converting said messages into short messages based on the protocols of the short messaging system used in the mobile telecommunications network as specified in for example in [3].

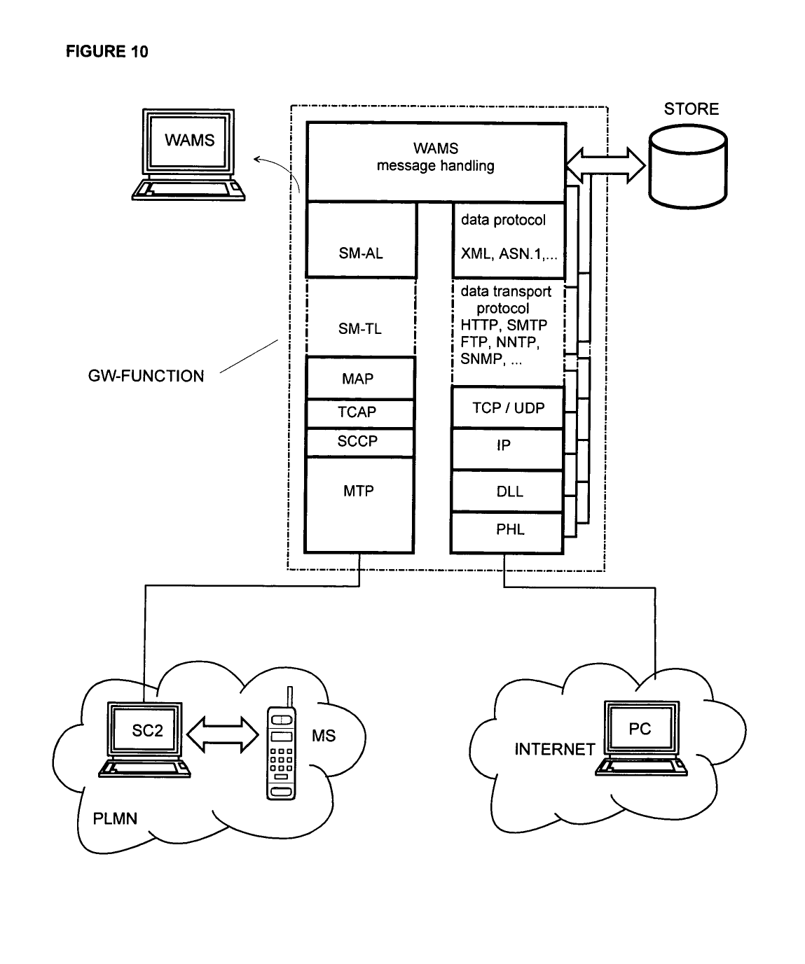

Implementation of a gateway function between an internet and a mobile telecommunications network PLMN within the message server WAMS is shown in FIG. 10. The application in the given example uses the Hypertext Transfer Protocol and the extensible Markup Language, XML.

The recipient application could receive HTTP requests (POST) containing the user data of a short message as follows:

<?xml version=“1.0”?>
<SMS MessageID=“11223344”>

<Sender>+41765552211</Sender>
<Text>ITEMS SOLD</Text>
<Time>12:02:00</Time>
<Date>12.01.2001</Time>

</SMS>

On the other hand the application could use a similar format to send a short message to a mobile station MS by using a HTTP request as follows:

<?xml version=“1.0”?>
<SMS>

<Destination>+41765552211</Destination>
<Text>PLEASE CALL PHONE NUMBER 800 33 22</Text>

</SMS>

In order to perform said HTTP requests for executing transfers of short messages simple PUSH/PULL routines have to be set up which act as an interface between an application and the message server WAMS.

The PUSH/PULL routines may be set up by using the Simple Object Access Protocol SOAP, which is a lightweight and simple XML-based protocol that is designed to exchange structured and typed information on the Web. The extensible Markup Language XML is a meta-markup language that provides a format for describing structured data. Binding SOAP to HTTP provides the advantage of being able to use the formalism and decentralised flexibility of SOAP with the rich feature set of HTTP. The purpose of SOAP is to enable rich and automated Web services based on a shared and open Web infrastructure. SOAP can be used in combination with a variety of existing Internet protocols and formats including HTTP, SMTP, and MIME and can support a wide range of applications including messaging systems. Information and specifications relating to SOAP are available under http://msdn.microsoft.com/xml/general/soapspec.asp.

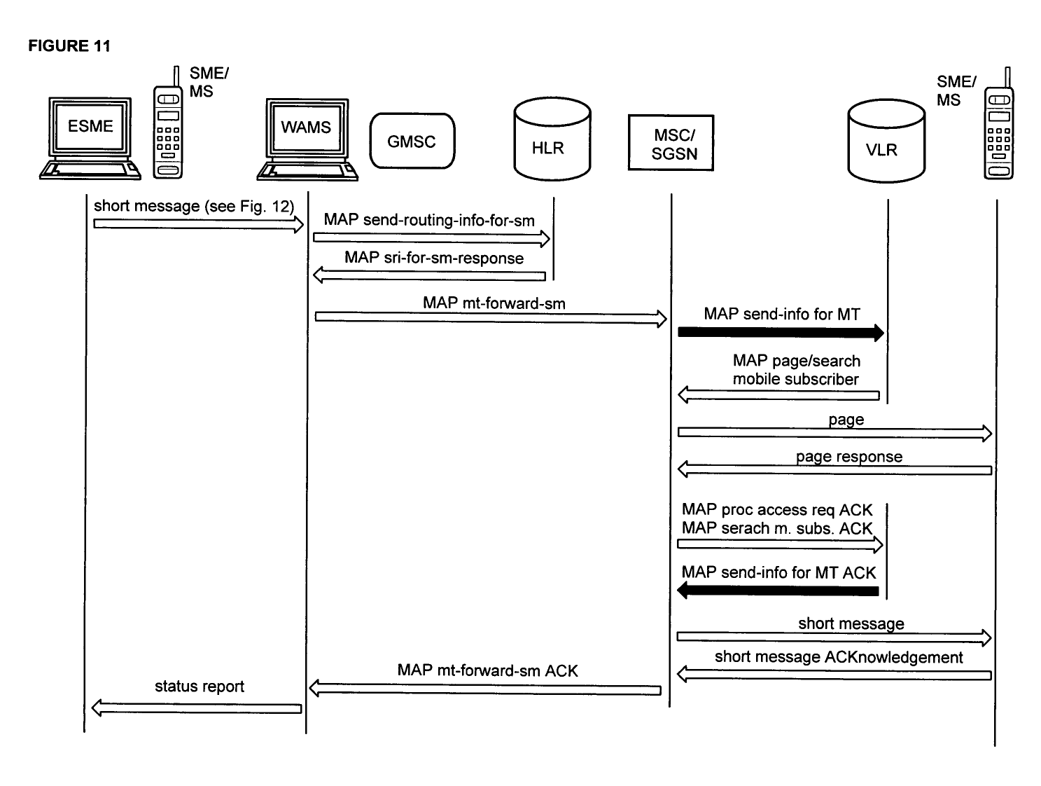

The transfer of messages received from the applications operating in a network such as an IP-network or from a mobile station connected to the mobile telecommunications network will be explained below with reference to FIG. 11. The message server WAMS, in this embodiment of the invention, will incorporate the functionality of a service center as described in [3], chapter 6, page 25 and [5], chapter 10, pages 159-170.

Since mobile stations are not always online, a “store-and-forward” mechanism is implemented. This means that if a application generates a mobile terminated message, the message server WAMS will store it first and then try to send it out. If the message can not be sent, the message server WAMS will follow a predefined retry scheme, trying to send the message after expiry of predefined intervals. After a given time period the message will be deleted. After successful delivery of the message the message server WAMS sends a delivery notification to the application. The protocols used between the entities were described above. In that way, the message server WAMS acts towards the mobile telecommunications network as a service center (see [3], chapter 6, page 25) implementing the procedures of the Mobile Application Part as described below.

As shown in FIG. 7 after the receipt of a short message from a internal or external short message entity, the message server WAMS, acting as a service center, will interrogate the home location register HLR by means of a SEND-ROUTING-INFO-FOR-SM in order to obtain routing information for the addressed subscriber. Afterwards the short message is forwarded by means of an MT-FORWARD-SM command to the mobile services switching center MSC visited by the addressed mobile station MS. The mobile services switching center MSC will then retrieve subscriber information from the visitor location register VLR by means of the SEND-INFO-FOR-MT command which may be returned after a paging and authentication process. Then the short message will be forwarded to the mobile station MS which will acknowledge receipt of the message. The mobile services switching center MSC will finally report the result of the transfer by means of a MT-FORWARD-SM-ACKNOWLEDGE message to the message server WAMS which will inform the originating application or mobile station accordingly.

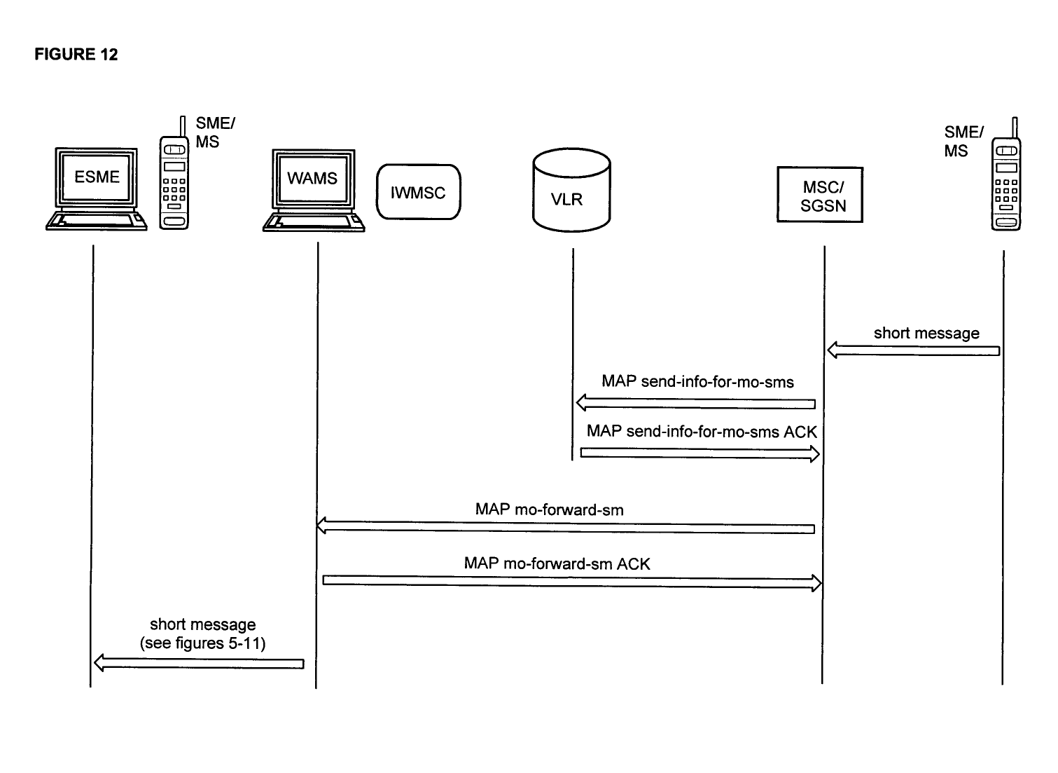

FIG. 12 shows the transfer of a message from a mobile station MS to the message server WAMS acting as a service center which is addressed by means of an E.164 number as described above. After receipt of the short message from the mobile station MS the mobile services switching center MSC interrogates the visitor location register VLR by means of a SEND-INFO-FOR-MO-SMS command in order to verify that the message does not violate the supplementary services invoked or the restrictions imposed. As described in [5], page 170 the address of the service center is also available in the visitor location register VLR. With a MO-FORWARD-SM command the short message is forwarded to the message server WAMS or a interworking unit IWMSC implemented therein as described in [5], page 587. The message server WAMS then forwards the short message to a connected internal or an external short message entity.

The message server WAMS operates in preferred embodiments as a service center enhanced with the capability of routing mobile originated messages received from any mobile station or service center to a recipient application or a related service in a network such as an IP-network which is not using the standards of the mobile telecommunications network.

References

[1] THE COMMUNICATIONS HANDBOOK, CRC PRESS, Boca Raton 1997

[2] B. Walke, Mobilfunknetze und ihre Protokolle, Band 1, B. G. Teubner Verlag, Stuttgart 2000

[3] GSM Specification 03.40 concerning the technical realisation of the Short Message Service (SMS), ETSI European Telecommunication Standard ETS 300 536 (October 1994)

[4] U.S. Pat. No. 5,768,509 (Gunlilk)

[5] GSM Technical Specification 09.02 (Mobile Application Part (MAP) specification) ETSI European Telecommunication Standard ETS 300 599 (February 1995)

[6] Wolf-Dieter Haaβ, Handbuch der Kommunikationsnetze, Springer Verlag, Berlin 1997

[7] Douglas E. Comer, INTERNETWORKING with TCP/IP, PRINCIPLES, PROTOCOLS, AND ARCHITECTURES, 4th EDITION, Prentice Hall 2000

[8] Andrew S. Tanenbaum, Computer Networks, Prentice-Hall Inc., Englewood Cliffs N.J. 1989, 2nd Edition

[9] SMPP Developers Forum, Short Message Peer to Peer Protocol Specification v3.4, Oct. 12, 1999, Issue 1.2

[10] ETSI Technical Report ETSI TR 123 039 V.3.2.0 (2000-09) Digital cellular telecommunications system (Phase2+)(GSM) Universal Mobile Telecommunications System UMTS;

Interface Protocols for the connection of Short Message Service Centres (SMSCs) to Short Message Entities (SMEs); (3GPP TR 23.039 version 3.2.0 Release 1999)

1. A method for conveying messages, particularly short messages, originating in a mobile telecommunications network such as a GSM, TDMA, CDMA or 3G (MMS) system and terminating at a recipient application (ESME, PC1, PC2, . . . ) or a related service in a network such as an IP-network which is not using the standards of said mobile telecommunications network comprising the steps of
a) providing a message server (WAMS) using signalling functions, such as the functions of the Signalling System Number 7, according to the standards of said mobile telecommunications network;
b) providing a database (HLRx) in said message server (WAMS) comprising routing information to said recipient application (ESME, PC1, PC2, . . . ) or the related service;
c) providing a switching function (MSCx) for transferring messages according to retrieved routing information;
d) an originating mobile station (MS) selecting an address of said message server (WAMS) as destination address which corresponds to a recipient application (ESME, PC1, PC2, . . . );
e) transmitting the message from the mobile station via a first service centre (SC2)to the message server (WAMS);
f) retrieving routing information from the database (HLRx, TB) based on the provided destination address and
g) forwarding the message by means of the switching function (MSCx) in the message server (WAMS) to the recipient application (ESME, PC1, PC2, . . . ) or the related service, or to a location accessible by the recipient application (ESME, PC1, PC2, . . . ) or the related service.

2. Method according to claim 1, wherein the message server (WAMS),
a) forwards messages via a service center (SC1) to recipient applications (ESME, PC1, PC2, . . . ),
b) terminates messages in a protocol stack comprising the layers of the signalling system and the short messaging system of the mobile telecommunications network (PLMN) and then stores the extracted contents, such as the user data of a protocol data unit SMS-DELIVER, in a storage facility (HLRx, TB, HD, DBMS) which contents are then, directly or via a proxy server, forwarded to or retrieved by the recipient applications (ESME, PC1, PC2, . . . ),
c) terminates messages in a protocol stack comprising the layers of the signalling system and the short messaging system of the mobile telecommunications network (PLMN) and then pushes the extracted contents, such as the user data of a protocol data unit SMS-DELIVER directly or via a proxy server to the recipient applications (ESME, PC1, PC2, . . . ) or
d) forwards messages to recipient applications hosted and/or operating within the message server (WAMS).

3. Method according to claim 1 or 2, wherein the message server (WAMS), comprising a gateway function (GW-FUNCTION),
a) in a first protocol stack terminates messages received from the mobile communications network and/or
b) in a second protocol stack terminates messages received from external short message entities (ESME, PC1, PC2, . . . ); operating in a different network, such as an IP-network;
thereby extracting the contents of the messages, which then, across the complementing second or first protocol stack, are transferred to their destinations; or which are stored and then retrieved by addressed short message entities (ESME, PC1, PC2, . . . ).

4. Method according to claim 1, 2 or 3, wherein the message server (WAMS), acting as short message service center, transfers messages between
a) short message entities, such as mobile stations (SME, MS1, MS2, . . . ) internal to the mobile telecommunications network (PLMN);
b) short message entities (ESME, PC1, PC2, . . . ), such as recipient applications in an IP-network, external to the mobile telecommunications network (PLMN); and
c) in both directions between internal short message entities (SME, MS1, MS2, . . . ) and external short message entities (ESME, PC1, PC2, . . . )
and further, as enhanced short message service center, transfers messages from internal short message entities (SME, MS1, MS2, . . . ) to external short message entities (ESME, PC1, PC2, . . . ) by means of destination addresses of virtual mobile stations that correspond to recipient applications (ESME, PC1, PC2, . . . ).

5. Method according to one of the claims 1 to 4, comprising the steps of
a) an originating mobile station (MS) selecting an address of said message server (WAMS) as destination address which corresponds to a recipient application;
b) transmitting the message to a first service centre (SC2)in the mobile telecommunications network;
c) the first service centre (SC2) using a related gateway function (GMSC) for retrieving routing information from the database (HLRx) of the message server (WAMS) based on the provided destination address and
d) forwarding the message through the switching function (MSCx) in the message server (WAMS) to a second service centre (SC1) hosting the recipient application or the related service.

6. Method according to one of the claims 1 to 5, wherein numbers of virtual mobile stations, having preferably the format of a standardised E.164 address number, are assigned as destination addresses to the recipient applications (ESME, PC1, PC2, . . . ) in order to access the message server (WAMS) or its elements (HLRx, MSCx) or wherein the message server (WAMS), acting as service center, is accessed by means of a given E.164 number.

7. Method according to one of the claims 1 to 6, wherein the information, such as the virtual mobile station number, used to access the message server (WAMS) or its functions (HLRx, MSCx) is originally provided in the user data or the signalling data, particularly as the originating address, of a former message sent by the recipient application (ESME, PC1, PC2, . . . ) or a related service.

8. Method according to one of the claims 1 to 7, wherein the message server (WAMS) handles the recipient applications (ESME, PC1, PC2, . . . ) or the related services as virtual mobile stations with the database (HLRx) of the message server (WAMS) containing at least
a) a Mobile Station International ISDN Number MSISDN serving as the virtual mobile station number related to the recipient application or the related service,
b) the International Mobile Station Identity IMSI corresponding to said Mobile Station International ISDN Number (MSISDN),
c) the address, such as an E.164 address, of the service centre (SC1) linked to the recipient application or the related service,
d) the address and preferably address type of the recipient application or the related service.

9. Method according to claim 8, in which
a) the first service centre (SC2) or the related gateway function (GMSC) uses the Mobile Station International ISDN Number MSISDN for retrieving the International Mobile Station Identity IMSI and the address of the switching function (MSCx) from the database (HLRx) of the message server (WAMS) preferably by means of a SEND-ROUTING-INFO-FOR-SM query,
b) the first service centre (SC2) or the related gateway function (GMSC) forwards the message to the switching function (MSCx) of the message server (WAMS) and
c) the switching function (MSCx) retrieves the address of the recipient application or the related service as well as the address of the service centre (SC1) linked to the recipient application or the related service and submits the message preferably with an SMS-SUBMIT event instead of an SMS-DELIVER event to the addressed service centre (SC1) and
d) the addressed service centre (SC1) based on routing information stored in a database forwards the message to the recipient application or a related service.

10. Method according to one of the claims 1 to 9, in which the database (HLRx) of the message server (WAMS), comprising routing information, is maintained by an operator (OP; SP) of a service provider such as the service provider SP related to said application and service; and/or in which transactions performed by said message server (WAMS) are counted and reported.

11. Message server (WAMS) for conveying messages, particularly short messages, originating in a mobile telecommunications network such as the GSM system and terminating at a recipient application (ESME, PC1, PC2, . . . ) or a related service in a network such as an IP-network which is not using the standards of said mobile telecommunications network, said message server (WAMS)
a) using signalling functions, such as the functions of the Signalling System Number 7, according to the standards of said mobile telecommunications network;
b) comprising a database (HLRx) containing routing information to said recipient application (ESME, PC1, PC2, . . . ) or the related service;
c) comprising a switching function (MSCx) for forwarding the message to the recipient application (ESME, PC1, PC2, . . . ) or the related service, or to a location accessible by the recipient application (ESME, PC1, PC2, . . . ) or the related service and
d) comprising a control unit (WAMSC) through which an operator can access and update at least said database (HLRx).

12. Message server (WAMS) according to claim 11, comprising a gateway function (GW-FUNCTION) with
a) a first protocol stack designed to terminate messages received from the mobile communications network and/or
b) a second protocol stack designed to terminate messages received from external short message entities (ESME, PC1, PC2, . . . ); operating in a different network, such as an IP-network;
in order to extract the contents of the received messages, which then, across the complementing second or first protocol stack are transferred to their destinations; or which are stored and then retrieved by addressed short message entities (ESME, PC1, PC2, . . . ).

13. Message server (WAMS) according to claim 12, wherein the gateway function (GW-FUNCTION) comprises a protocol stack with the layers of the signalling system and the short messaging system of the mobile telecommunications network (PLMN) on one side and with the protocol stack used by the external short message entities (ESME, PC1, PC2, . . . ) comprising
a) layers of a network protocol such as TCP/IP;
b) a layer of a data transport protocol such as HTTP, SMTP, FTP, NNTP, SNMP; and
c) a layer of a data protocol such as XML, ASN.1, derivatives thereof.

14. Message server (WAMS) according to claim 11, 12 or 13, designed as short message service center, capable of transferring messages between
a) short message entities, such as mobile stations (SME, MS1, MS2, . . . ) internal to the mobile telecommunications network (PLMN);
b) short message entities, such as recipient applications (ESME, PC1, PC2, . . . ) in an IP-network, external to the mobile telecommunications network (PLMN); and
c) in both directions between internal short message entities (SME, MS1, MS2, . . . ) and external short message entities (ESME, PC1, PC2, . . . )
and further designed to transfer messages from internal short message entities (SME, MS1, MS2, . . . ) to external short message entities (ESME, PC1, PC2, . . . ) by means of destination addresses of virtual mobile stations incorporated in the message server (WAMS) that correspond to recipient applications (ESME, PC1, PC2, . . . ).

15. Message server (WAMS) according to one of the claims 11 to 14, comprising at least one storage facility (HLRx, TB, HD, DBMS) such as a random access memory, a hard-disk a Storage Area Network (SAN), or a database managed by a high level application; designed to store routing information and/or terminated messages or extracted content, such as the user data of a protocol data unit SMS-DELIVER.

16. Message server (WAMS) according to one of the claims 11 to 15, wherein storage facility (HLRx, TB, HD, DBMS) is accessible by recipient applications (ESME, PC1, PC2, . . . ) or a proxy server in order to retrieve received messages or contents.

17. Message server (WAMS) according to one of the claims 11 to 16, hosting recipient applications.

18. Message server (WAMS) according to one of the claims 11 to 17, in which the database (HLRx) contains at least
a) the Mobile Station International ISDN Number MSISDN related to the recipient application or the related service,
b) the International Mobile Station Identity IMSI corresponding to said Mobile Station International ISDN Number MSISDN,
c) the address, such as an E.164 address, of the service centre (SC1) linked to the recipient application or the related service,
d) the address and preferably address type of the recipient application or the related service.

19. Message server (WAMS) according to one of the claims 11 to 18, in which the database (HLRx) operates according to the specification of a home location register (HLR) of a GSM system and in which the switching function (MSCx) operates according to the specification of a mobile services switching centre (MSC) of a GSM system.

20. Telecommunications network for conveying messages, particularly short messages, originating in a mobile telecommunications network such as the GSM system and terminating at a recipient application or a related service in a network not using the standards of said mobile telecommunications network, comprising a message server (WAMS) according to one of the claims 11 to 19, through which messages arriving at a first service centre (SC2) can be routed to the recipient application or the related service.

21. Telecommunications network according to claim 20, wherein the message server (WAMS) is designed as short message service center, capable of transferring messages between
a) short message entities, such as mobile stations (SME, MS1, MS2, . . . ) internal to the mobile telecommunications network (PLMN);
b) short message entities (ESME, PC1, PC2, . . . ), such as recipient applications in an IP-network, external to the mobile telecommunications network (PLMN); and
c) in both directions between internal short message entities (SME, MS1, MS2, . . . ) and external short message entities (ESME, PC1, PC2, . . . );
and wherein the message server (WAMS) is further designed to transfer messages from internal short message entities (SME, MS1, MS2, . . . ) to external short message entities (ESME, PC1, PC2, . . . ) by means of destination addresses of virtual mobile stations incorporated in the message server (WAMS) that correspond to recipient applications (ESME, PC1, PC2, . . . ).
